(19) United States
(12) Patent Application Publication
(10) Pub. No.: US 2010/0325220 A1
(43) Pub. Date: Dec. 23, 2010

(54) Systems and Methods for Subscribing to an Information Feed

(76) Inventors: James Skinner, Singapore (SG); Michael Hewitt, South Jordan, UT (US); Douglas Weber, Salt Lake City, UT (US); Gilbert Reimschussel, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/490,260

(22) Filed: Jun. 23, 2009

(51) Int. Cl. G06F 15/16; G06F 17/30

(52) U.S. Cl. 709/206; 709/246; 709/224; 707/912; 707/955; 707/812

(57) ABSTRACT

Systems and methods are disclosed for receiving and processing a subscription request by e-mail to an information stream. The systems and methods involve a network-based information storage and distribution system for receiving, storing, and distributing an information stream to a subscriber of the information stream over a network. The system receives an e-mail subscription request from a subscriber seeking to subscribe to an information stream, where the e-mail subscription request includes stream-identifying information identifying the information stream to which the subscriber wishes to subscribe; and an e-mail address for the subscriber, which may simply be determined by way of examining the return e-mail address of the e-mail sender from the e-mail. The e-mail is used to determine which information stream is to be subscribed to from the stream-identifying information, and the subscriber's e-mail address is used to provide access to the information stream to the subscriber.

### BACKGROUND OF THE INVENTION

1. Field of the Invention

The present invention relates to subscribing to an information feed, and more particularly to systems and methods for subscribing to an information feed by e-mail.

2. Background and Related Art

Many Internet sites, such as YouTube, Scribd, Twitter, and YouPublish provide a method for various users to post content, such as video files, audio files, photographs, or text to the Internet. In some instances, the files are stored and/or converted into a format that can be viewed, listened to, or otherwise accessed using a user's browser, such as by converting such files to Flash. In some instances, the Internet site, such as Posterous, allows a user to post content to the site by sending the content as an attachment by e-mail, in the body of the e-mail, or by short message service (SMS), multimedia messaging service (MMS), or text message.

Sites such as Twitter further allow a user to go to the site, find one or more other users of interest, and subscribe to that user's content. Upon subscribing to the content, the subscriber is then provided with updates of the subscribed-to content, such as by receiving e-mail notifications of posts from the subscribed-to user, receiving notifications in the site's interface when the subscriber later accesses the site, or by using a really simple syndication (RSS) feed.

Although these systems and sites provide mechanisms to provide updated information to subscribers, these systems require a user desiring to subscribe to another user's posts to access the host site, identify the user whose posts are to be subscribed to, and subscribe to the information. Additionally, if the subscriber desires to receive e-mail notifications (if available), the user must input an e-mail address where the notifications are to be sent. This subscription method is time-consuming and inconvenient. Additionally, this process may be difficult or impossible to do from many cell phones and other similar devices, which may not include or support a browser capable of accessing the subscription site, or if capable of accessing the site may have small screens on which it is difficult to view and use the subscription site. Such devices may be further limited by communications bandwidth limitations when trying to access and navigate the subscription site.

### BRIEF SUMMARY OF THE INVENTION

Implementation of the invention provides systems and methods for receiving and processing a subscription request by e-mail to an information stream. Implementation of the invention involves a network-based information storage and distribution system for receiving, storing, and distributing an information stream to a subscriber of the information stream over a network. The system receives an e-mail subscription request from a subscriber seeking to subscribe to an information stream, where the e-mail subscription request includes stream-identifying information identifying the information stream to which the subscriber wishes to subscribe, and an e-mail address for the subscriber, which may simply be determined by way of examining the e-mail address of the e-mail sender from the e-mail. The e-mail is used to determine which information stream is to be subscribed to from the stream-identifying information, and the subscriber's e-mail address is used to provide access to the information stream to the subscriber.

The stream-identifying information may include any of a variety of identifying information. In some implementations, the e-mail address to which the e-mail is sent identifies the stream to which subscription is desired. In other implementations, a subject of the e-mail or a body of the e-mail provides the stream-identifying information. In still other implementations, an attachment to the e-mail provides the stream-identifying information. Regardless of how the stream-identifying information is included in the e-mail, the e-mail subscription process allows users to subscribe to another user's posts or to some other pre-existing or customized content stream by merely sending an e-mail or other short message containing information identifying the content stream to which the subscriber wishes to subscribe.

The system is implemented across one or more network-connected devices, such as servers, server clusters, or the like. This provides a network-connected information storage and distribution system for receiving, storing, and distributing a content stream to a subscriber of the content stream over a network and for receiving a subscription request to the content stream by e-mail. The system may include an incoming request processor configured to receive and process e-mail directed to the system, such as a subscription request e-mail from a subscriber containing the stream-identifying information and the subscriber's e-mail address.

The system also includes a database of accounts that post content to provide the information streams, along with the information or content streams of posts for each account that posts content. The system maintains a database of subscribers to the various content stream and utilizes an outgoing e-mail processor for handling notifications of new posts.

As content may be posted in a variety of formats, the system may be configured to modify or convert posts from their original format to one or more other formats to facilitate access by the subscriber. This conversion may be based on one or more factors, including a hardware and/or software configuration of the device to be used to access the content and a communication speed of the connection between the system and the device to be used to access the content. The content may be converted into various formats as it is received, or it may be converted on demand as the content is delivered to the subscribers.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer environment for use with embodiments of the invention;

FIG. 2 shows a representative network environment for use with embodiments of the invention;

FIG. 3 shows a depiction of an embodiment of a system for receiving and processing e-mail requests to subscribe to an information feed;

FIG. 4 shows an alternate depiction of an embodiment of a system for receiving and processing e-mail requests to subscribe to an information feed;

FIGS. 5A and 5B provide a flowchart depicting a process for receiving and processing e-mail requests to subscribe to an information feed;

FIG. 6 shows using an e-mail server to receive e-mail requests to a system for receiving and processing e-mail requests to subscribe to an information feed; and

FIG. 7 shows a representative e-mail request to post information to a content stream.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for receiving and processing a subscription request by e-mail to an information stream. Embodiments of the invention utilize a network-based information storage and distribution system for receiving, storing, and distributing an information stream to a subscriber of the information stream over a network. The system receives an e-mail subscription request from a subscriber seeking to subscribe to an information stream, where the e-mail subscription request includes stream-identifying information identifying the information stream to which the subscriber wishes to subscribe, and an e-mail address for the subscriber, which may simply be determined by way of examining the e-mail address of the e-mail sender from the e-mail. The e-mail is used to determine which information stream is to be subscribed to from the stream-identifying information, and the subscriber's e-mail address is used to provide access to the information stream to the subscriber.

The stream-identifying information may include any of a variety of identifying information. In some embodiments, the e-mail address to which the e-mail is sent identifies the stream to which subscription is desired. In some embodiments, a subject of the e-mail or a body of the e-mail provides the stream-identifying information. In some embodiments, an attachment to the e-mail provides the stream-identifying information. Regardless of how the stream-identifying information is included in the e-mail, the e-mail subscription process allows users to subscribe to another user's posts or to some other pre-existing or customized content stream by merely sending an e-mail or other short message such as SMS, MMS, or text message, containing information identifying the content stream to which the subscriber wishes to subscribe.

The system is implemented across one or more network-connected devices, such as servers, server clusters, or the like. This provides a network-connected information storage and distribution system for receiving, storing, and distributing a content stream to a subscriber of the content stream over a network and for receiving a subscription request to the content stream by e-mail. The system may include an incoming request processor configured to receive and process e-mail directed to the system, such as a subscription request e-mail from a subscriber containing the stream-identifying information and the subscriber's e-mail address.

The system also includes a database of accounts that post content to provide the information streams, along with the information or content streams of posts for each account that posts content. The system maintains a database of subscribers to the various content streams and utilizes an outgoing e-mail processor for handling notifications of new posts.

As content may be posted in a variety of formats, the system may be configured to modify or convert posts from their original format to one or more other formats to facilitate access by the subscriber. This conversion may be based on one or more factors, including a hardware and/or software configuration of the device to be used to access the content and a communication speed of the connection between the system and the device to be used to access the content. The content may be converted into various formats as it is received, or it may be converted on demand as the content is delivered to the subscribers.

In such embodiments, when a user attempts to access the content, such as by browsing the site where the content is uploaded or posted, or by clicking on a link to the content, a determination is made as to the type of device attempting to access the content, a characteristic thereof, and/or the device's configuration. The determination may be made by any method, such as receiving a user access device characteristic from the user at a time of subscription to an information stream comprising multiple media files or at a time of registration to use the system, receiving a user access device characteristic from the user at a time of requesting access to a media file, detecting a user access device characteristic by pinging the user access device, detecting a user access device characteristic by pinging the user's browser, detecting a user access device characteristic from device information included in a communication sent from the user access device, detecting a user access device characteristic based on the network or IP address from which the access request is received, detecting a user access device characteristic based on an error generated in attempting to view a media file of an unsupported type, and detecting a user access device characteristic based on the carrier or communications provider from which the access request is received.

Although the discussion provided herein is focused on embodiments where an e-mail is used to subscribe to a content stream or other content source, it should be understood that embodiments of the invention embrace many types of communications seeking subscription to a content stream without requiring a potential subscriber to visit a content-intensive web site via a browser. For example, embodiments of the invention enable subscription requests to be sent and received via short message service (SMS) messages, multimedia message service (MMS) messages, text messages (texts) and may utilize similar mechanisms for providing notifications of updates to subscribers.

Additionally, where e-mail addresses are referred to herein, it should be understood that any unique user identifier and/or other information may be used to identify a subscriber and direct notifications to that subscriber. As one example only, the subscriber's cell phone number may be used as an identifier and notifications may be sent to the subscriber's cell phone using the cell phone number. As new communications methods emerge, it is anticipated that embodiments of the invention can be adapted to such communication methods. For example, Google is currently developing a new communication and collaboration system titled Wave (see http://wave.google.com). As Google Wave is developed and begins being used, it is anticipated that embodiments of the invention may be adapted to interact with this new system and provide user updates through this system. Thus, embodiments of the invention embrace the use of many types of user identifications, including instant messaging (IM) user IDs, Google Wave user IDs, webmail user IDs, e-mail addresses, telephone numbers, and the like, and wherever e-mail addresses are referred to herein, such reference should include any type of current or future user ID, as long as such understanding is consistent with the specific use and reference.

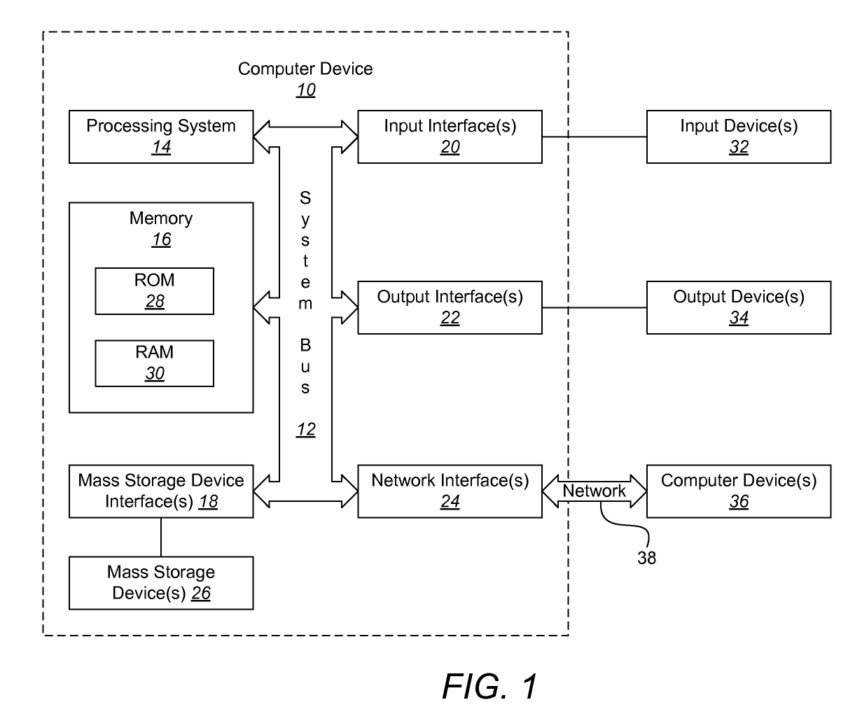

As embodiments of the invention embrace the use of network-connected consumer electronic devices and various network-connected computer devices, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer, or a consumer electronic device. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, flash memory drives, and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

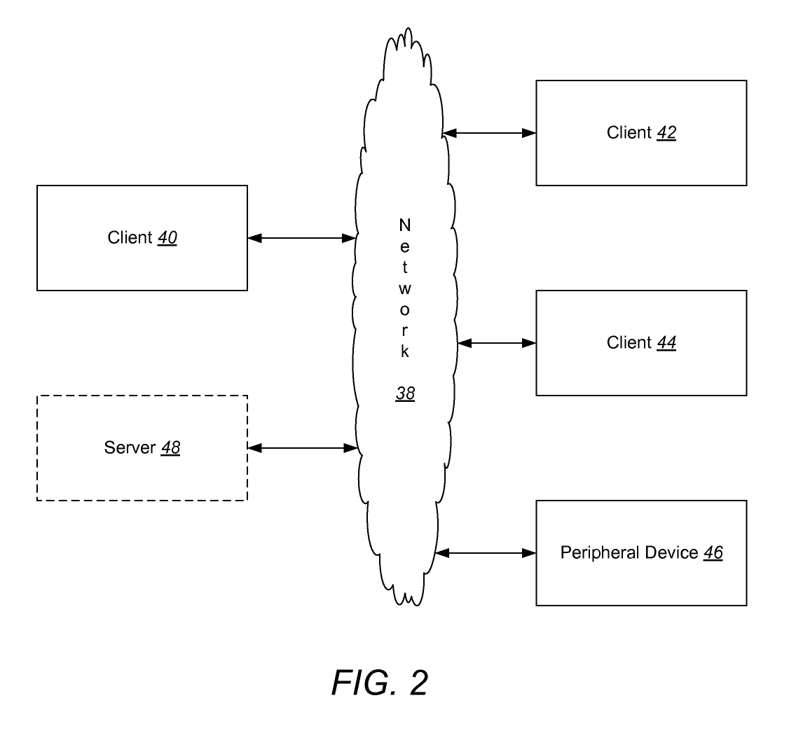

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Each of the clients 40, 42, or 44, or client computer devices can be any of a wide range of computer and consumer devices configured for connection to the network 38. Non-limiting examples of such devices include cell phones, smart phones, netbooks, laptops, tablet computers, personal/desktop computers running any of a variety of operating systems, workstations, personal data assistants (PDAs), electronic readers, wireless reading devices, e-book readers, or any other current or future computer device configured for at least intermittent access to the network 38.

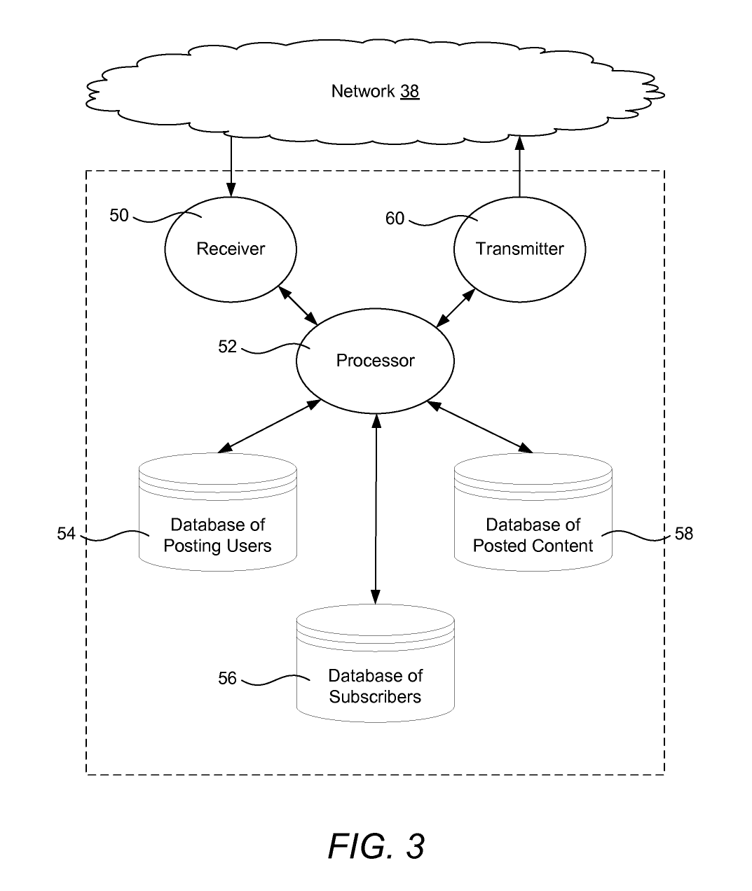

FIG. 3 shows one possible configuration of a network-connected system for receiving and processing an e-mail subscription request to subscribe to an information stream, updated content posts, or the like. The system is connected to the network 38 and may be implemented across one or more or a variety of computer devices, including servers and the like. The system includes a receiver 50. The receiver 50 receives e-mails over the network 38 from users, including users wishing to subscribe to an information stream or other content. When the e-mail is a subscription request, the e-mail is configured to include information identifying the content stream to which the subscriber wishes to subscribe. This identifying information may be included in a variety of ways.

For example, in one embodiment, the e-mail is addressed to a unique e-mail address identifying the content to which the subscriber wishes to reply. As one non-limiting example, the e-mail may be addressed in a fashion similar to get.username@mobjet.com, where “username” is the name of the user generating the desired content stream by posting updates or is some other unique code identifying the desired content stream. In such an embodiment, the system may generate an e-mail account within the domain name having the “get.username” format for each individual content stream to which it is possible to subscribe, or the system may simply accept any e-mail addressed to an e-mail address ending in the domain name (e.g. @mobjet.com). If all e-mails are accepted, the system may later determine whether a username matching the identified “username” exists.

In another embodiment, the e-mail contains information identifying the desired content stream in a subject line of the e-mail. In another embodiment, the e-mail contains the identifying information within a body of the e-mail. In another embodiment, the e-mail contains key words (for example, a celebrity's name and “photo”, to key in on new photos of that celebrity), which are matched to posts to the system and/or available information streams/sources to generate a subscription information stream unique to that subscriber. In another embodiment, the e-mail contains an attachment containing stream-identifying information. Regardless of how the identifying information is contained in the e-mail, the e-mail is passed to a processor 52, which identifies the user (content poster) or information stream being subscribed to or generates a new customized information stream by reference to the information contained in the e-mail address, subject line, or e-mail body. The processor 52 identifies the user or information stream by reference and comparison to a database of posting users 54, which represents a mapping between an e-mail address from which posts may be received and a content stream to which content is posted. If a password is required to subscribe to a particular user's content or content stream, the password may be included in the subscription e-mail, such as in the body or header, and the processor 52 determines if the necessary password is present before confirming subscription.

Once the processor 52 identifies the desired information stream to which subscription is sought, the subscriber's e-mail address (or other unique identifying and communication-directing information, as discussed above) is recorded in a database of subscribers 56. The subscriber's e-mail address may be the e-mail address from which the subscription e-mail was sent or may be another address identified in the e-mail, and is therefore obtained from the subscription e-mail and included in the database of subscribers 56. When the subscriber's e-mail address or other information is recorded in the database of subscribers 56, it is recorded along with an identification of the user or data stream to which the subscriber is subscribed. Thus, the database of subscribers 56 includes information mapping a subscriber to a subscribed content stream.

When content is posted to a content stream, the system notifies those subscribed to that content stream of the posted content and provides the posted content to the subscribers. Therefore, the system maintains a database of posted content 58 for delivery of the posted content to subscribers. The database of posted content 58 may be designed to be a collection of all content posted by an account, and is where each post resides. When content is sent to or accessed by subscribers, it is linked from the database of posted content 58.

The system additionally contains a transmitter 60 for transmitting information to the subscribers over the network 38. Thus, when new content is posted and it is determined that a particular subscriber should be notified and/or provided access to the content, the transmitter 60 transmits an e-mail to the e-mail address of the subscriber recorded in the database of subscribers 56. If the subscriber is to receive notifications by a mechanism other than e-mail (e.g. IM, SMS, MMS, text message, etc., the system utilizes that mechanism to notify the subscriber of the new content.

In some instances, the e-mail sent by the transmitter 60 includes a link to access the post or other updated information, or a link to a page having additional links to the posts or one or more components thereof (e.g. direct linking and/or indirect linking). The subscriber then is able to access the post or updated information by selecting the link (or links), whereupon the post or other information is accessed by the subscriber, such as in a browser or by providing the post or content in streaming fashion to an application on a device used by the subscriber, or by some other fashion. This delivery method may be useful in a variety of instances, including but not limited to instances where the size of the post or updated information is larger than is desirable to send by e-mail

In other instances, the post or other updated information itself is contained in the body of the e-mail or as an attachment thereto. This delivery method may be useful in a variety of instances, including instances where the post consists entirely of text, when the subscriber receiving the notification does not have access to a web browser, such as for some cell phone users, or in instances where the subscriber has elected to receive all content within the e-mail.

Regardless of how content is delivered to the subscriber (as a link within the e-mail or delivered with the e-mail itself, or by some other mechanism), it may be desirable to format the content into a format that facilitates access by the subscriber. Therefore, some embodiments of the system include the capability of converting posted content from one or more initial formats into one or more other formats. For example, the system may convert posted content into easily-viewable file formats, such as Flash, portable document format (PDF), and the like. As another example, the system may convert posted content into formats that take into account various access variables with respect to the various subscribers, such as hardware and software configurations of the subscribers' access devices, as well as communication speeds between the system and the subscribers' access devices.

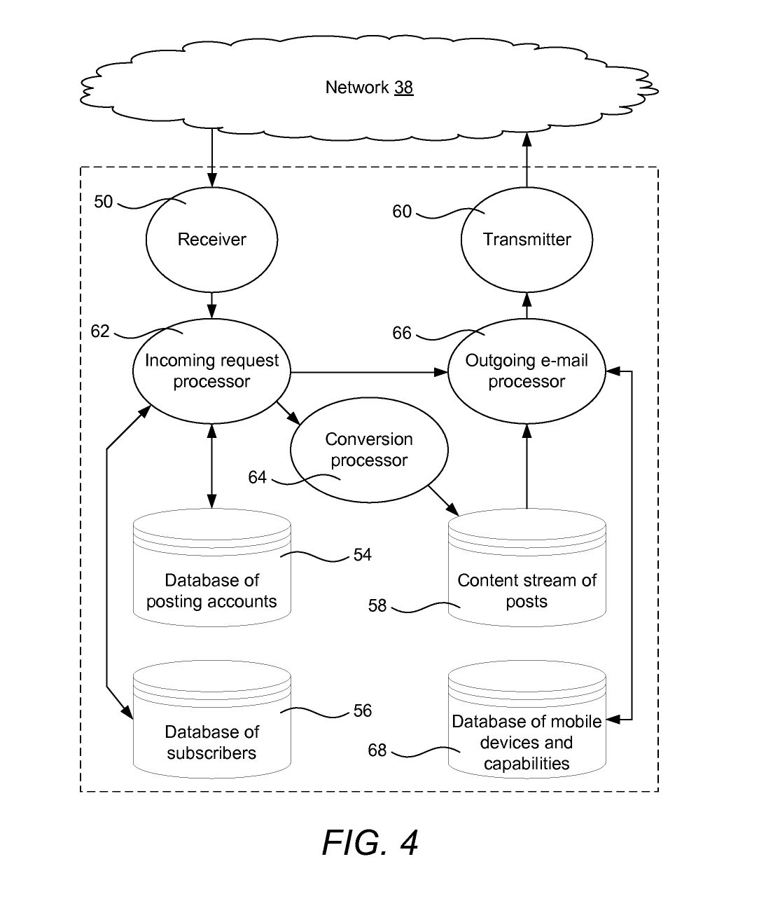

For example, many cell phones have the ability to display pictures and video, but have limited screen sizes. Additionally, cell phones have varying communications rates, and the communications rate of an individual cell phone may vary depending on a cell phone user's location within a cell phone network. If a content-posting user posts a video in lossless high definition (HD) format, it may be undesirable to deliver the video in that format to a subscriber's cell phone, and the cell phone may, in fact, be completely unable to display a video thus formatted. If, however, the video is first converted to a lower resolution and compressed format, the cell phone may be better able to receive and display the video in a meaningful way to the subscriber. Additionally, some cell phone devices are configured with players capable of playing files of one type, say .mp4 video files, while others require another type, such as .3gp files, and so forth. Therefore, FIG. 4 displays an alternate embodiment or depiction of the content subscription and delivery system, this embodiment being configured to convert content into one or more alternate formats for facilitating subscriber access to the content.

In this embodiment, the system includes an incoming request processor 62 that handles incoming requests received by the receiver 50. The incoming requests need not be limited to subscription requests, but may include requests to unsubscribe to a content stream, requests from content-posting users to post content, requests to cancel an account (either from a subscriber or a content-posting user), requests for support, reports of abuse, or any other type of incoming request. The incoming request processor 62 processes the requests and responds to the requests appropriately, executing the appropriate action according to the incoming request.

The receiver 50 and the incoming request processor 62 receives the incoming requests using any of a variety of formats. E-mails may be received using the Internet message access protocol (IMAP) or any other protocol. Although many requests may be received by e-mail, other requests may be received and handled by the incoming request processor 62 by other mechanisms, including requests received from a web site interface (e.g. a form post or a link click to perform the request), and requests received through an application programming interface (API) such as of a third-party application sending the request. In at least some embodiments, any type of request can be received using any of the possible request avenues, so although many subscription requests may be received by e-mail, other subscription requests can be received by APIs and web site interfaces.

If the incoming request is a post request containing content, the content may be passed to a conversion processor 64. The conversion processor 64 serves to convert or modify the content in a way that facilitates subscriber access. Although one conversion processor 64 is illustrated, it should be understood that multiple or many conversion processors 64 may be used to convert files of various types and formats (e.g. a different conversion processor 64 may be used for images vs. videos, images of one file type vs. another, etc.). The conversion processor 64 converts recognized incoming media into one or more of a variety of standard and targeted encodings, including resolutions and compression settings. For example, a Word document may be converted to a PDF document or another targeted format. A high-resolution Quicktime movie may be converted into a lower resolution movie and/or to another format, such as .mp4 or .3gp. Such conversions facilitate an optimal consumption experience for the subscribers of the content stream.

The conversion processor 64 may provide the converted content to the content stream of posts or the database of posted content 58, where the converted content may be accessed by an outgoing e-mail processor 66 for inclusion in an e-mail to the subscriber to be sent over the network 38 by the transmitter 60. Alternatively, the converted content may be accessed by the subscriber selecting a link in the notification e-mail as described above.

The outgoing e-mail processor 66 may also handle all outgoing messages sent to subscribers and content-posting users. Such messages include but are not limited to content stream creation notifications, posted content notifications, subscriber request notifications, successful subscription notifications, forgotten password notifications, account authenticity notifications, summary notifications, error notifications, and the like. In some instances, it is not desirable to send out notifications and e-mails upon every update to an information feed. Instead, some embodiments either batch outgoing messages and notifications to a given e-mail address into a single summary notification or e-mail or permit a user to elect such summary notifications or e-mails at a user-selected frequency.

As the system is designed to facilitate user access to content, the system may be configured to determine hardware and software configurations of the subscriber access device or to receive a notification from the subscriber of such configurations. In some embodiments, the system can detect the hardware and software configurations, such as by using a user agent to detect a browser header. Another manner of detecting the hardware and/or software configurations or modes is by detecting device information included in e-mails sent by the user device, such as header information. Other manners of detecting a device characteristic of the hardware and/or software configuration include: receiving the user access device characteristic from the user at a time of subscription to an information stream comprising multiple media files or at a time of registration to use the system, receiving the user access device characteristic from the user at a time of requesting access to a media file, detecting the user access device characteristic by pinging the user access device, detecting the user access device characteristic by pinging the user's browser, detecting the user access device characteristic from device information included in a communication sent from the user access device, detecting the user access device characteristic based on the network or IP address from which the access request is received, detecting the user access device characteristic based on an error generated in attempting to view a media file of an unsupported type, and detecting the user access device characteristic based on the carrier or communications provider from which the access request is received.

By detecting the hardware and/or software configurations or modes, the system can deliver a file format that is supported for viewing on the user access device. To facilitate this delivery, the system maintains a database of devices and capabilities 68. The database of devices and capabilities 68 contains a list of devices on which posted content could be consumed. This database includes information that improves the subscriber's content consumption experience, such as any of determining the proper encodings, file types, resolutions, compression codecs, etc. to present to the user access device.

When the user accesses content or when the system attaches content to a notification e-mail, the system (such as through the outgoing e-mail processor 66 for outgoing e-mails) determines the applicable hardware and software configurations, references the database of mobile devices or browsers and their associated capabilities 68, and provides access to the content in the database of posted content 58 in a format determined to enhance and facilitate subscriber access through the access device. This determination may also or alternatively take into account a connection or communication speed between the system and the access device, such that content is timely delivered regardless of the communication speed. While any of a variety of factors may be considered when delivering access to the content, non-limiting examples of some factors for consideration include: the make and model of the access device, the operating system of the device, access programs available on the device, the data transfer speed, the native screen resolution of the device, the browser being used, etc. Thus the content may be delivered in a manner that is more convenient and enjoyable to the subscriber.

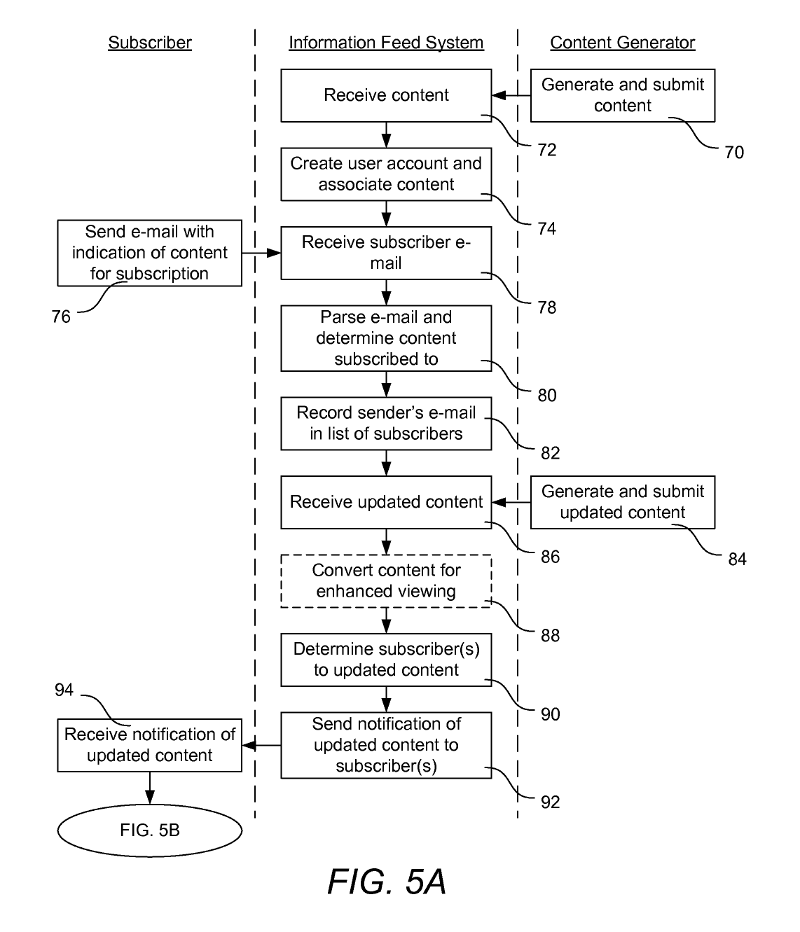

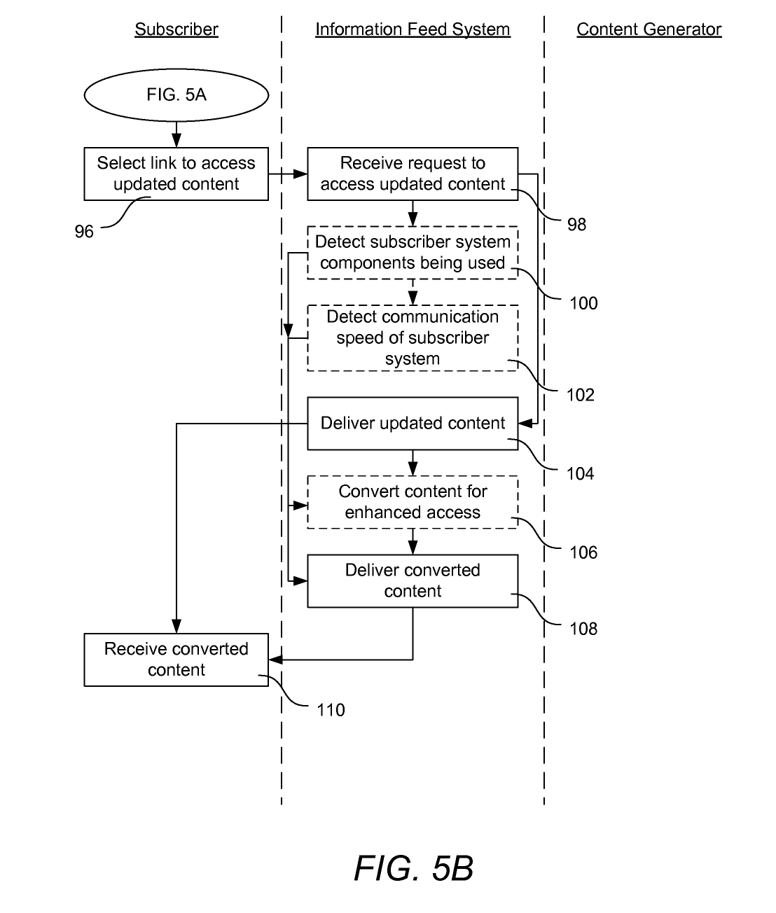

In some instances, content may be converted into a variety of formats, encodings, resolutions, and the like, immediately upon receipt. In other instances, it may be desirable to convert or modify content on the fly, either at the time of sending notifications to subscribers or at the time subscribers attempt to access the content. In still other instances, a hybrid approach may be used, where the content is converted or partially converted into some formats, resolutions, and the like, immediately upon receipt and into other formats, resolutions, and the like, at a later time. Each conversion time has certain advantages. Early conversion facilitates maximum speed of delivery to subscribers upon request. Later conversion may avoid conversion into unneeded formats and may save storage space. Thus, different instances and different embodiments may opt for conversion at different times as is illustrated in the flow charts of FIGS. 5A and 5B.

FIGS. 5A and 5B depict an illustrative process for subscription to and delivery of content posted by a content generator on an information feed system and subscribed to by a subscriber. Execution begins at step 70, where the content generator generates and submits content. The information feed system receives the content at step 72, and if the content generator has not yet been assigned a content feed/user account, or the like, the system creates an account at step 74. Once an account is active, the subscriber can request a subscription to the account, such as by e-mail at step 76, which is received by the system at step 78. The system parses the e-mail to determine to what content the subscriber wishes to subscribe in step 80 and records the subscriber's e-mail in a list of subscribers in step 82.

When the content generator generates new or updated content at step 84 and the system receives it at step 86, the system may optionally convert content for enhanced viewing at step 88. Regardless of whether content is converted at step 88, execution proceeds to step 90, where the system determines the subscribers to which access to the updated content should be provided. Once the subscribers are determined, the system sends notifications of updated content to the subscribers at step 92, and the subscribers receive the notifications at step 94. If the notifications include the content itself, the content may be modified content as discussed above.

If, instead, a link is provided to access the content, each subscriber selects the link to access the updated content at step 96, and the system receives the request to access the updated content at step 98. The system may optionally detect or determine the subscriber system components (e.g. hardware and software configuration) being used at step 100 and may alternatively or additionally detect or determine a communication speed of the subscriber system at step 102. If, however, no detection or determination occurs, the updated content is delivered at step 104.

If one or more of the detection/determining steps 100, 102 occurs, execution may proceed to either of steps 106 or 108, depending on whether the updated content is already in a format configured for an optimal subscriber experience. If the content either already is stored in an optimal format (e.g. was received in that format at step 86) or has already been converted to an optimal format at step 88, the content is delivered at step 108. If, however, the content should be converted to optimize the subscriber experience, it is first converted at step 106 before being delivered by the system at step 108. The updated content is received by the subscriber at step 110 and is consumed by the subscriber using the subscriber's access device, whatever it may be.

In some embodiments, the system is configured to detect hardware and/or software being used on the accessing device when the accessing device is used by the subscriber to attempt to access content via a link, as discussed above. In some instances, the device hardware and/or software configuration is one not included in the database of devices and capabilities 68. If the device hardware and/or software configuration is not included in the database of devices and capabilities 68, the system stores and/or outputs the detected data on the device and/or software making the request to access content via the link. Such information can be used in various ways. In one example, the information is used to look up, research, or otherwise determine the capabilities of the device and its software so the system can provide content to the device in a format designed to enhance the subscriber's experience. In another example, it may be determined that the number of subscribers having configurations similar to those detected and added to the system do not merit supporting or fully supporting the detected configuration, in which case partial support may be provided or the system may track the number of subscribers having that configuration until that number justifies the resources to support or fully support the detected configuration. In this way, the system can dynamically adjust to and support new devices and capabilities to enhance subscribers' consumption experiences.

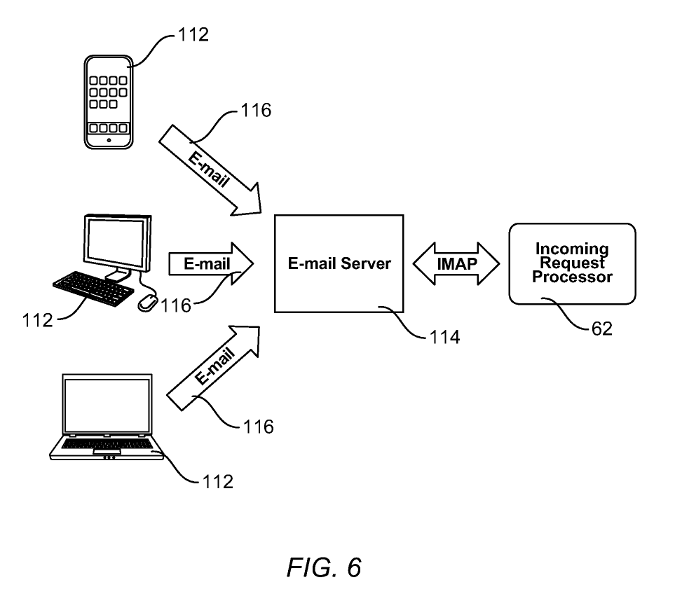

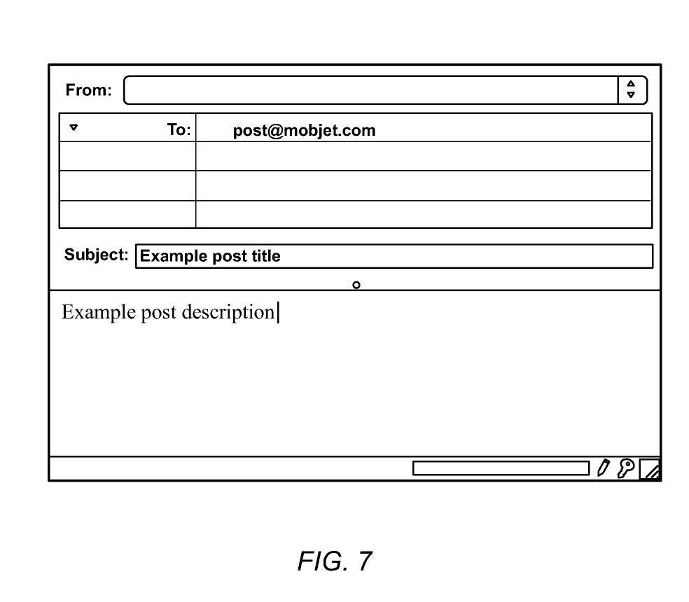

Although discussed in detail above, FIG. 6 provides an illustration of various devices 112 communicating with an e-mail server 114 by e-mails 116. The e-mails are delivered over the network 38. The e-mail server 114 is illustrated as communicating information to the incoming request processor in response to the e-mails 116. Therefore, embodiments of the invention embrace the use of an e-mail server in the system. FIG. 7 provides an illustration of an exemplary e-mail format for posting content to an information feed as discussed above.

Thus, embodiments of the invention provide systems and methods for receiving and processing a subscription request by e-mail to an information stream. The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. In a network-based information storage and distribution system for receiving, storing, and distributing an information stream to a subscriber of the information stream over a network, a method for receiving a subscription request to the information stream comprising:
receiving an e-mail subscription request from a subscriber seeking to subscribe to an information stream, the e-mail subscription request comprising:
stream-identifying information identifying the information stream to which the subscriber wishes to subscribe; and
an e-mail address for the subscriber;
determining which information stream is to be subscribed to from the stream-identifying information; and
using the subscriber's e-mail address to provide access to the information stream to the subscriber.

2. A method as recited in claim 1, wherein the stream-identifying information comprises an e-mail address to which the subscription request is sent.

3. A method as recited in claim 2, wherein the e-mail address to which the subscription request is sent comprises a text string identifying the information stream.

4. A method as recited in claim 3, wherein the information stream comprises posts by a posting user, and wherein the text string identifying the information stream comprises a username or other user identifier of the posting user.

5. A method as recited in claim 1, wherein the stream-identifying information is contained in one of:
a subject line of the e-mail subscription request;
a body of the e-mail subscription request; and
an attachment to the e-mail.

6. A method as recited in claim 1, wherein the stream-identifying information comprises one or more keywords, the method further comprising:
matching the one or more keywords to information received by the system to generate a customized information stream customized for the subscriber;
matching new information received by the system to the one or more keywords; and
notifying the subscriber when new information is received by the system that matches the one or more keywords.

7. A method as recited in claim 1, wherein using the subscriber's e-mail address to provide access to the information stream to the subscriber comprises:
recording the subscriber's e-mail address as subscribing to the information stream;
receiving content posted to the information stream; and
transmitting an e-mail to the subscriber's e-mail address when content is posted to the information stream, the e-mail to the subscriber's e-mail address comprising one of:
a link to access the content over the network; and
the content.

8. A method as recited in claim 7, wherein using the subscriber's e-mail address to provide access to the information stream to the subscriber further comprises:
converting the content into one or more formats configured for facilitated access by a consumer device of the subscriber; and
delivering the content to the consumer device of the subscriber in one of the one or more formats.

9. A method as recited in claim 7, further comprising:
determining one of:
a hardware configuration of the consumer device;
a software configuration of the consumer device; and
a hardware and software configuration of the consumer device; and
selecting one of the one or more formats that is suitable for the determined configuration of the consumer device.

10. A method as recited in claim 9, wherein the consumer device is one of:
a cell phone;
a smart phone;
a netbook;
a laptop computer;
a tablet computer;
a desktop computer;
a workstation;
a personal digital assistant (PDA);
an electronic reader; and
a wireless reading device.

11. A method as recited in claim 7, further comprising:
detecting a communication speed of the consumer device; and
selecting one of the one or more formats that is suitable for the communication speed of the consumer device.

12. A method as recited in claim 1, wherein using the subscriber's e-mail address to provide access to the information stream to the subscriber comprises:
recording the subscriber's e-mail address as subscribing to the information stream;
receiving content posted to the information stream;
converting the content into a plurality of formats configured for facilitated access by a consumer device of the subscriber;
transmitting an e-mail to the subscriber's e-mail address when content is posted to the information stream, the e-mail to the subscriber's e-mail address comprising a link to access the content over the network;
receiving a selection of the link from the subscriber;
determining a determined configuration selected from the group of:
a hardware configuration of the consumer device;
a software configuration of the consumer device;
a hardware and software configuration of the consumer device; and
a communication speed of the consumer device;
selecting one of the formats based on at least one of the determined configuration and the determined communication speed; and
delivering the content in the selected format to the subscriber.

13. A method as recited in claim 12, wherein converting the content into the plurality of formats occurs prior to transmission of the e-mail to the subscriber's e-mail address with the link to access the content.

14. A method as recited in claim 12, wherein converting the content into the selected format of the plurality of formats occurs upon reception of the selection of the link from the subscriber and selection of one of the formats based on at least one of the determined configuration and the communication speed.

15. A method as recited in claim 12, further comprising maintaining a database of consumer devices and file formats supported on each consumer device for use in selecting one of the formats based on the determined configuration of the consumer device.

16. A method as recited in claim 12, further comprising maintaining a database of consumer device capabilities containing:
consumer device capabilities selected from the group of:
hardware capabilities;
software capabilities; and
hardware and software capabilities; and
information identifying how the information stream should be formatted to enhance a subscriber consumption experience based on the consumer device capabilities.

17. A method as recited in claim 16, further comprising:
determining that the determined configuration is not included in the database of consumer device capabilities;
adding the determined configuration to the database of consumer device capabilities;
identifying how the information stream should be formatted to enhance the subscriber consumption experience for the determined configuration; and
adding how the information stream should be formatted to enhance the subscriber consumption experience for the determined configuration to the database of consumer device capabilities.

18. A method as recited in claim 1, further comprising determining an access device characteristic of an access device used by the subscriber to seek access to the information stream, the access device characteristic being used for formatting the information stream to enhance a subscriber consumption experience, wherein determining the access device characteristic comprises at least one of:
receiving the access device characteristic at a time of subscription or system registration;
receiving the access device characteristic at a time of accessing the information stream;
detecting the access device characteristic by pinging the user access device;
detecting the access device characteristic by pinging the user's browser;
detecting the access device characteristic from device information included in a communication sent from the access device;
detecting the access device characteristic based on a network from which the access request is received;
detecting the access device characteristic based on a carrier or communications provider from which the access request is received; and
detecting the access device characteristic based on an error generated in attempting to view a media file of an unsupported type.

19. A network-connected information storage and distribution system for receiving, storing, and distributing a content stream to a subscriber of the content stream over a network and for receiving a subscription request to the content stream by e-mail comprising:
an incoming request processor configured to receive and process e-mail directed to the system, wherein one type of e-mail that the incoming request processor is configured to receive and process is a subscription request e-mail from a subscriber comprising:
stream-identifying information identifying a content stream to which the subscriber wishes to subscribe; and
a return e-mail address for the subscriber;
a database of accounts that post content;
a content stream of posts for each account that posts content;
a database of subscribers to the content stream; and
an outgoing e-mail processor for handling notifications of new posts.

20. A system as recited in claim 18, wherein the incoming request processor is configured to handle all incoming requests, including e-mails containing content for posting, e-mails containing requests for subscription to a content stream; and e-mails containing requests for unsubscription to a content stream.

21. A system as recited in claim 18, further comprising a conversion processor configured to convert incoming posted content into a format for distribution to subscribers.

22. A system as recited in claim 20, further comprising a device database containing a list of devices on which posted content could be consumed, wherein the conversion processor uses the device database to determine formats for conversion of the posted content for distribution.

23. In a network-based information storage and distribution system for receiving, storing, and distributing user-updated posts of information to a subscriber of the information posts over a network from one or more network-connected servers, a method for receiving a subscription request to the information posts and distributing updated posts of information comprising:
receiving an e-mail subscription request from a subscriber seeking to subscribe to a posting user's information posts, the e-mail subscription request comprising:
post-identifying information identifying the information posts to which the subscriber wishes to subscribe; and
an e-mail address for the subscriber;
determining which information posts are to be subscribed to from the post-identifying information;
receiving an updated post of information from a content-posting user;
determining that the subscriber is subscribed to posts of information from the content-posting user;
using the subscriber's e-mail address to provide access to the updated information post to the subscriber in a format configured for access by a consumer device of the subscriber.

24. A method as recited in claim 22, wherein providing access to the updated information post to the subscriber in a format configured for access by the consumer device comprises:
determining at least one of:
a hardware and software configuration of the consumer device; and
a communication speed of the consumer device;
converting the updated information post into a converted format designed to facilitate access to the updated information post according to at least one of the hardware and software configuration and the communication speed; and
delivering the updated information post to the consumer device in the converted format.

25. In a network-based information storage and distribution system for receiving, storing, and distributing an information stream to a subscriber of the information stream over a network, a method for receiving a subscription request to the information stream comprising:
receiving a subscription request from a subscriber seeking to subscribe to an information stream, the subscription request comprising:
a form of communication not generated by dedicated subscription site for subscription to the information stream;
stream-identifying information identifying the information stream to which the subscriber wishes to subscribe; and
a return communication identifier identifying how access to the information stream is to be provided to the subscriber;
determining which information stream is to be subscribed to from the stream-identifying information; and
using the subscriber's return communication identifier to provide the subscriber access to the information stream.

26. A method as recited in claim 24, wherein the form of communication comprises one of:
an e-mail;
a text message;
a short message service message;
a multimedia messaging service message;
an instant message;
a collaborative communication thread message; and
a message stream message.
